(19) United States
(12) Patent Application Publication
(10) Pub. No.: US 2024/0296474 A1
(43) Pub. Date: Sep. 5, 2024

(54) METHOD AND APPARATUS FOR PROVIDING CREDIT FOR RETAIL PURCHASES

(71) Applicant: Coapperate, LLC, Sarasota, FL (US)

(72) Inventor: Michael D. Wyckoff, Sarasota, FL (US)

(21) Appl. No.: 18/593,542

(22) Filed: Mar. 1, 2024

Related U.S. Application Data
(60) Provisional application No. 63/487,889, filed on Mar. 2, 2023.

(51) Int. Cl. G06Q 30/0234; G06Q 30/0207

(52) U.S. Cl. CPC G06Q 30/0234; G06Q 30/0222

(57) ABSTRACT

An apparatus for increasing retail sales of goods and services over a communications network includes one or more processors, and an application service executed by the one or more processors, the application service configured to: obtain, from a retailer server, data defining an offer, the data indicating one or more application features corresponding to the application service, each application feature of the one or more application features having feature enablement criteria corresponding to the application feature, receive, from a first client application via the communications network, a selection of an application feature, the first client application executing on a first client device, receive, from the retailer server, a first indicator indicating that the feature enablement criteria has been satisfied, and in response to receipt of the first indicator, provide, to the first client application, a second indicator indicating that the selected application feature is enabled.

### CROSS-REFERENCE TO RELATED APPLICATIONS

This patent application claims priority to provisional patent application No. 63/487,889 filed Mar. 2, 2023 and titled “Method and System for Providing Credit for Retail Purchases.” The subject matter of provisional patent application No. 63/487,889 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The claimed subject matter relates to the field of electronic commerce and, more specifically, the claimed subject matter relates to processes for increasing retail sales of goods and services.

### BACKGROUND

The global mobile application market size was valued at about $200 billion in 2022 and is expected to grow at a compound annual growth rate through 2030. Applications abound for gaming, mobile health and fitness, music and entertainment, social networking, retail and e-commerce, and other purposes. The ubiquity of smartphones, rising internet usage, and the use of technologies like artificial intelligence and machine learning in mobile applications all point to future growth in demand for mobile applications. Video games, also known as computer games, are electronic games that involve interaction with a user interface or input device-such as a joystick, controller, keyboard, or motion sensing device-to generate audiovisual feedback. Since its inception, the commercial importance of the video game industry has been increasing. As of 2020, for example, the global video game market has estimated annual revenues of $159 billion across hardware, software, and services. This is three times the size of the 2019 global music industry and four times that of the 2019 film industry.

On the other hand, in recent years, the retail industry has experienced a shift towards online shopping, leading to a decrease in foot traffic in physical stores. This trend has led to a need for innovative solutions to drive sales and increase customer engagement in physical retail spaces. Some known approaches for increasing retail purchases include utilizing various techniques to enhance the customer experience and drive sales, such as providing personalized recommendations, and implementing interactive displays. Retailers use data analytics to gather information about customer preferences and behaviors and apply this information to create a personalized shopping experience. These approaches aim to engage customers and encourage them to interact with products, while the interactive displays provide customers with an immersive and interactive shopping experience. The result, however, is that these approaches have not met expectations for increasing sales for retailers.

Additionally, as a consequence of the retail industry's response to the shift towards online shopping, competition among online retailers has increased substantially as more and more online retailers flood the marketplace, making it more difficult for retailers to acquire new customers, maintain their customer bases, and also increasing the cost of customer acquisition.

Therefore, what is needed is a system and method for improving the problems with the prior art, and more particularly for a more expedient and efficient method and system for increasing retail sales of goods and services.

### BRIEF SUMMARY

In one embodiment, an apparatus for increasing retail sales of goods and services over a communications network is disclosed. The apparatus comprises one or more processors, and an application service executed by the one or more processors, the application service configured to: obtain, from a retailer server, data defining an offer, the data indicating one or more application features corresponding to the application service, each application feature of the one or more application features having feature enablement criteria corresponding to the application feature, receive, from a first client application via a communications network, a selection of an application feature of the one or more application features, the first client application executing on a first client device, receive, from the retailer server, a first indicator indicating that the feature enablement criteria has been satisfied, and in response to receipt of the first indicator, provide, to the first client application, a second indicator indicating that the selected application feature is enabled.

Additional aspects of the claimed subject matter will be set forth in part in the description which follows, and in part will be obvious from the description, or may be learned by practice of the claimed subject matter. The aspects of the claimed subject matter will be realized and attained by means of the elements and combinations particularly pointed out in the appended claims. It is to be understood that both the foregoing general description and the following detailed description are exemplary and explanatory only and are not restrictive of the disclosed subject matter, as claimed.

### BRIEF DESCRIPTION OF THE SEVERAL VIEWS OF THE DRAWINGS

The accompanying drawings, which are incorporated in and constitute part of this specification, illustrate embodiments of the claimed subject matter and together with the description, serve to explain the principles of the claimed subject matter. The embodiments illustrated herein are presently preferred, it being understood, however, that the claimed subject matter is not limited to the precise arrangements and instrumentalities shown, wherein:

FIG. 1 is a block diagram illustrating the network architecture of a system for increasing retail sales of goods and services over a communications network, in accordance with one embodiment.

FIG. 2A is a block diagram showing the data flow of the process for increasing retail sales of goods and services over a communications network, according to a first embodiment.

FIG. 2B is a block diagram showing the data flow of the process for increasing retail sales of goods and services over a communications network, according to a second embodiment.

FIG. 3A is a flow chart depicting the general control flow of a process for increasing retail sales of goods and services over a communications network, according to the first embodiment.

FIG. 3B is a flow chart depicting the general control flow of a process for increasing retail sales of goods and services over a communications network, according to the second embodiment.

FIG. 4 is a block diagram depicting a system including an example computing device and other computing devices.

### DETAILED DESCRIPTION

In the following detailed description of embodiments of the present disclosure, reference is made to the accompanying drawing figures in which like references indicate similar elements, and in which is shown by way of illustration specific embodiments in which the present disclosure may be practiced. These embodiments are described in sufficient detail to enable those skilled in the art to practice the present disclosure, and it is to be understood that other embodiments may be utilized and that logical, mechanical, electrical, functional, and other changes may be made without departing from the scope of the present disclosure. The following detailed description is, therefore, not to be taken in a limiting sense, and the scope of the present disclosure is defined only by the appended claims. As used in the present disclosure, the term “or” shall be understood to be defined as a logical disjunction and shall not indicate an exclusive disjunction unless expressly indicated as such or notated as “xor.”

The disclosed embodiments improve upon the problems with the prior art by providing a system that increases retail sales of goods and services by providing credit to consumers in response to retail sales of said goods and services. The claimed embodiments allow a purchaser of goods and services to attribute the purchase to a consumer, such that a credit is given to the consumer, which he can use while using his application. Therefore, the disclosed embodiments reduce or eliminate the need for the consumer to purchase credits while using his application or in-app. This is advantageous for consumers, as it provides an additional method for the consumer to gain credits for use in the application. An additional benefit of the disclosed embodiments is increased sales for the retailer, as consumers and their friends/family are enticed to shop at said retailer in order to gain credits for the consumer for use while using the application. The main benefit of the claimed subject matter is the increase in commerce, both in the use of applications and increased sales for retailers.

The disclosed embodiments further improve upon the problems with the prior art by enabling applications to be drivers of subscribers, users and customers for retailers in exchange for enhanced features, functionalities, for which a retailer could compensate the publishers or developer of said applications.

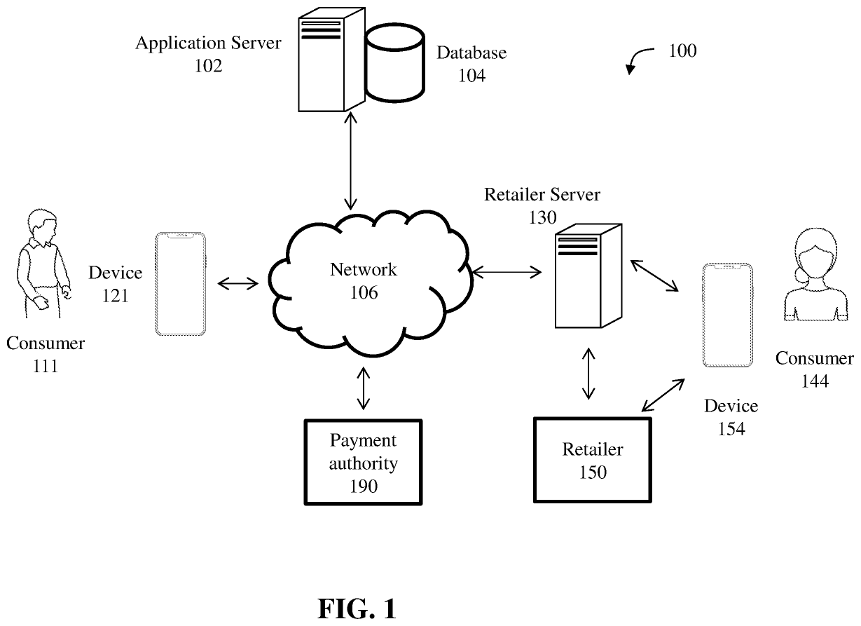

Referring now to the drawing figures in which like reference designators refer to like elements, there is shown in FIG. 1 an illustration of a block diagram showing the network architecture of a system 100 and method for increasing retail sales of goods and services over a communications network in accordance with one embodiment. A prominent element of FIG. 1 is the server 102 associated with repository or database 104 and further communicatively coupled with network 106, which can be a circuit switched network, such as the Public Service Telephone Network (PSTN), or a packet switched network, such as the Internet or the World Wide Web, the global telephone network, a cellular network, a mobile communications network, or any combination of the above. Server 102 is a central controller or operator for functionality of the disclosed embodiments, namely, increasing retail sales of goods and services. Server 102 may be a server, workstation, virtual machine or the like that executes application services that service one or more mobile applications. Application services are a pool of services provided by an application server that are needed to optimally deploy, run and manage a mobile application. Application services are software solutions that improve the speed, security, and operability of a mobile applications. The application service executing on server 102 may include one or more application program interfaces (APIs) configured to receive and transmit different types of data. The application service may further be configured to provide program code to modify a user interface (UI) of a client application to display one or more graphical elements.

FIG. 1 includes mobile computing device 121 utilized by user or consumer 111 and computing device 154 utilized by user or consumer 144 which may be smart phones, mobile phones, tablet computers, handheld computers, laptops, or the like. In another embodiment, mobile computing device 121 and 154 may be workstations, desktop computers, servers, laptops, all-in-one computers, or the like. In another embodiment, mobile computing device 121 and 154 may be augmented reality (AR) or virtual reality (VR) systems that may include display screens, headsets, heads up displays, helmet mounted display screens, tracking devices, or the like. The client computing devices 121 and 154 may execute a client application such as a mobile gaming application or any other application. In other embodiments, the client application may be a gaming application, health and fitness application, music application, entertainment application, social networking application, work application, business application, retail application, e-commerce application, or any application for other purposes. In another embodiment, the client computing devices 121 and/or 154 may execute a client application such as a retail application, a product or service purchase application, a retailer application, a credit acquisition application, an enablement criteria application, a sales application, or the like.

FIG. 1 also shows servers 102, 130, which may be workstations, servers, or the like. Devices 121, 154, 102, 130 may be communicatively coupled with network 106 in a wired or wireless fashion. FIG. 1 also shows a consumer 144, which may be the same person as consumer 111 or a different person. FIG. 1 also shows consumer 111 and consumer 144, who may be using the same device.

FIG. 1 further shows that server 102 includes a database or repository 104, which may be a cloud database stored in the cloud. Devices 121, 154, 102, 130 may also each include their own database. The repository 104 serves data from a database, which is a repository for data used by server 102 and devices 121, 154, 130 during the course of operation of the disclosed embodiments. Database 104 may be distributed over one or more nodes or locations that are connected via network 106.

The database 104 may include a user record for each user or consumer 111 or 144. A user record may include: contact/identifying information for the user (name, address, telephone number(s), email address, etc.), information pertaining to credits associated with the user, contact/identifying information for friends of the user, electronic payment information for the user, information pertaining to the purchases made by the user, sales transaction data associated with the user, etc. A user record may also include a unique identifier for each user, a residential address for each user, the current location of each user (based on location-based services from the user's mobile computer) and a description of past goods/services purchased by each user. A user record may further include demographic data for each user, such as age, sex, income data, race, color, marital status, etc. A user record may also include contact information (email address, name, address, telephone number, etc.) or a unique identifier for one or more friends or acquaintances of the user. A user record may also include a user credit, which is a credit that is used by a consumer while using an application, such as while using a video game during gameplay. Said credit can be used to purchase or receive virtual goods, real goods, virtual services, real services, etc. Credit refers to any medium of exchange, which can include digital currency, purchase cards, gift cards, player credits, points, etc. Credit may also refer to features, functionality or a virtual good itself, such as a skin, an avatar, a virtual good, etc. Note the consumer 144 may be the recipient of a credit, not just the consumer 111.

Sales transaction data may include one or more product/service identifiers (such as SKUs), one or more product/service amounts, buyer contact/identifying information, brick and mortar outlet information, and electronic payment information. In one embodiment, electronic payment information may comprise buyer contact/identifying information and any data garnered from a purchase card (i.e., purchase card data), as well as any authentication information that accompanies the purchase card. Purchase card data may comprise any data garnered from a purchase card and any authentication information that accompanies the purchase card. In one embodiment, electronic payment information may comprise user login data, such as a login name and password, or authentication information, which is used to access an account that is used to make a payment.

The database 104 may include a record for each offer. An offer may include one or more application features corresponding to an application service, wherein each application feature has feature enablement criteria. An application feature may be a credit, a gameplay feature, increased or enhanced health, abilities, powers or skills, a skin, a weapon, an avatar, unlocking levels, game currency, or the like. An offer may also include one or more user qualification criteria, one or more offer items, or one or more offer locations. Feature enablement criteria may comprise one or more of a purchase amount, a purchase of at least one of the one or more offer items, or an indication that a client device is located in proximity to at least one of the one or more offer locations.

FIG. 1 shows an embodiment wherein networked computing devices 121, 154, 130, 190 interact with server 102 and repository 104 over the network 106. It should be noted that although FIG. 1 shows only the networked computers 121, 154, 130, 190 and 102, the system of the disclosed embodiments supports any number of networked computing devices connected via network 106. Further, server 102, and units 121, 154, 130, 190 include program logic such as computer programs, mobile applications, executable files or computer instructions (including computer source code, scripting language code or interpreted language code that may be compiled to produce an executable file or that may be interpreted at run-time) that perform various functions of the disclosed embodiments.

Note that although server 102 is shown as a single and independent entity, in one embodiment, the functions of server 102 may be integrated with another entity, such as one of the devices 121, 154, 130, 190. Further, server 102 and its functionality, according to a preferred embodiment, can be realized in a centralized fashion in one computer system or in a distributed fashion wherein different elements are spread across several interconnected computer systems.

FIG. 1 also shows a payment authority 190, which acts to effectuate payments by consumer 111 or consumer 144 for credits provided to consumer 111 or consumer 144, or the like. In the course of a sales transaction, server 102, retailer 150 or retailer server 130 may interface with payment authority 190 to effectuate payment. In one embodiment, the payment authority 190 is a payment gateway, which is an e-commerce Application Service Provider (ASP) service that authorizes and processes payments from one party to another. The payment authority 190 may accept payment via the use of purchase cards, i.e., credit cards, charge cards, bank cards, gift cards, account cards, etc.

FIG. 1 also shows a retailer 150, which represents a retailer of goods or services engaged in commerce activities. The retailer 150 may be a retail store, a shop, a department store, a fast-food restaurant, an ecommerce store, a restaurant, a cafeteria, a music venue, a sports venue, a theater, an arena, a stage, an amphitheater, an outdoor concert structure, stadium, bandshell, bandstand, concert hall, opera house, nightclub, discotheque, park, bar, pub, sports complex, etc. The retailer 150 may be online, digital, virtual or brick and mortar, and the like. The retailer server 130 may represent the information technology infrastructure, including servers and computers, which are used by the retailer 150 to control and manage sales transaction data for retail sales of goods and services.

The consumer 111 or consumer 144 may enroll and register with server 102 and/or server 130. In the course of enrolling or registering, the users may enter data into their device by manually or automatically entering data into a mobile application via keypad, touchpad, or via voice or other means. In the course of enrolling or registering, the users may enter any data that may be stored in a user record, as defined above. Also in the course of enrolling or registering, the server 102 and/or server 130 may generate a user record for each registering user and store the user record in an attached database, such as database 104.

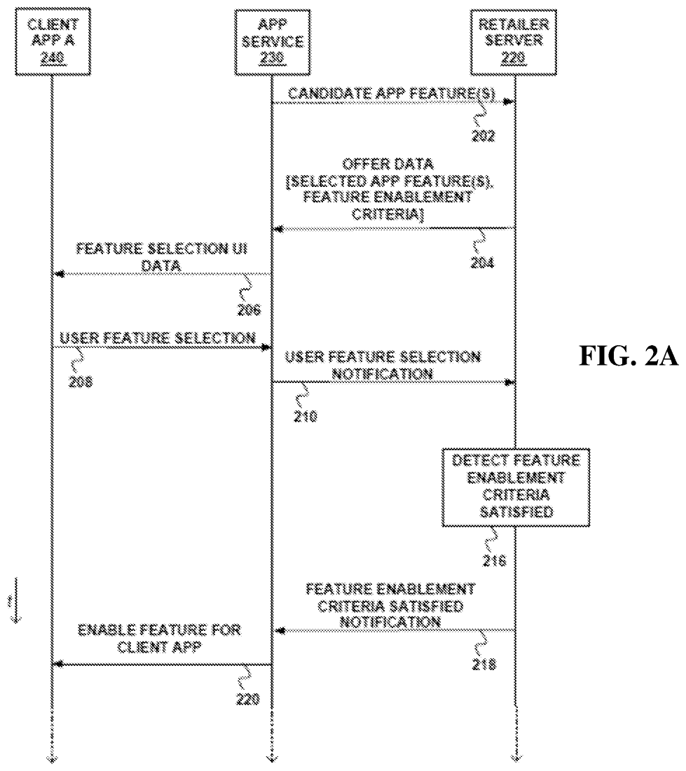

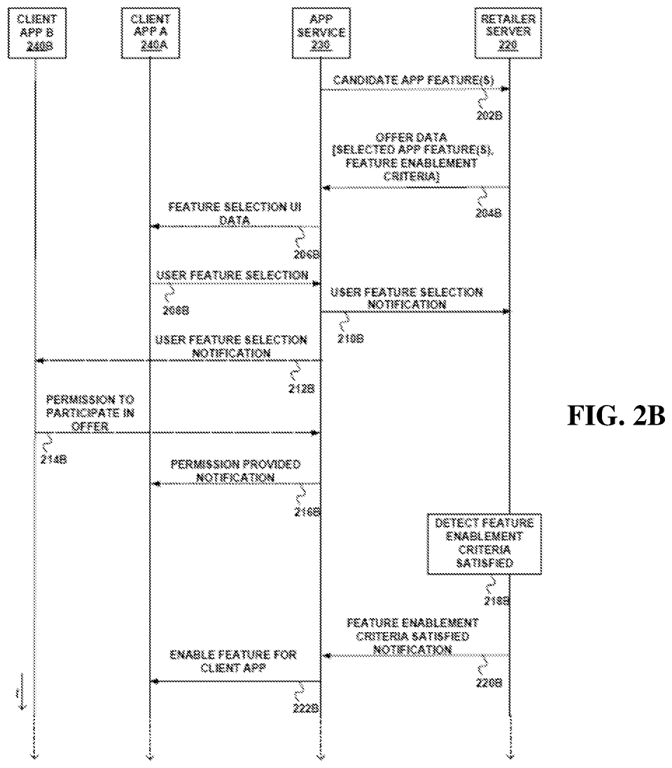

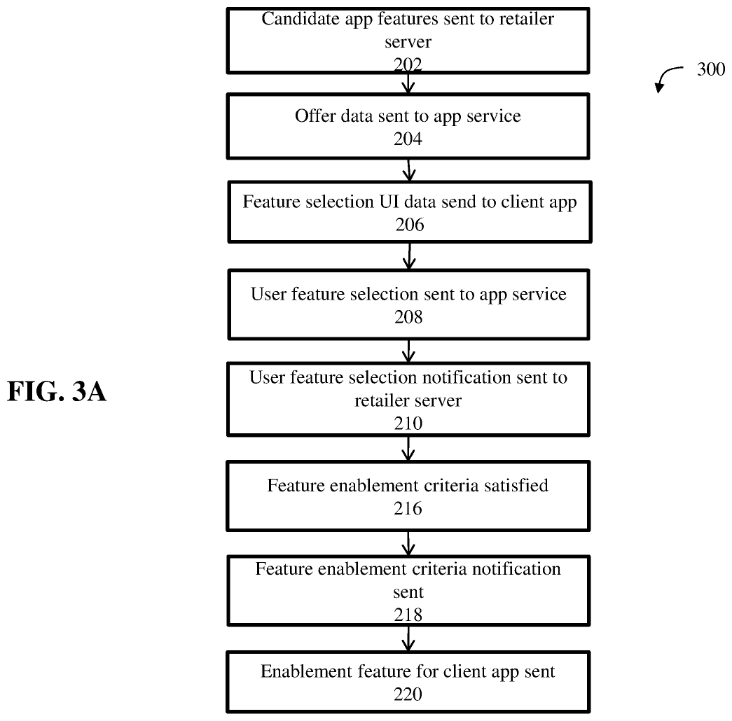

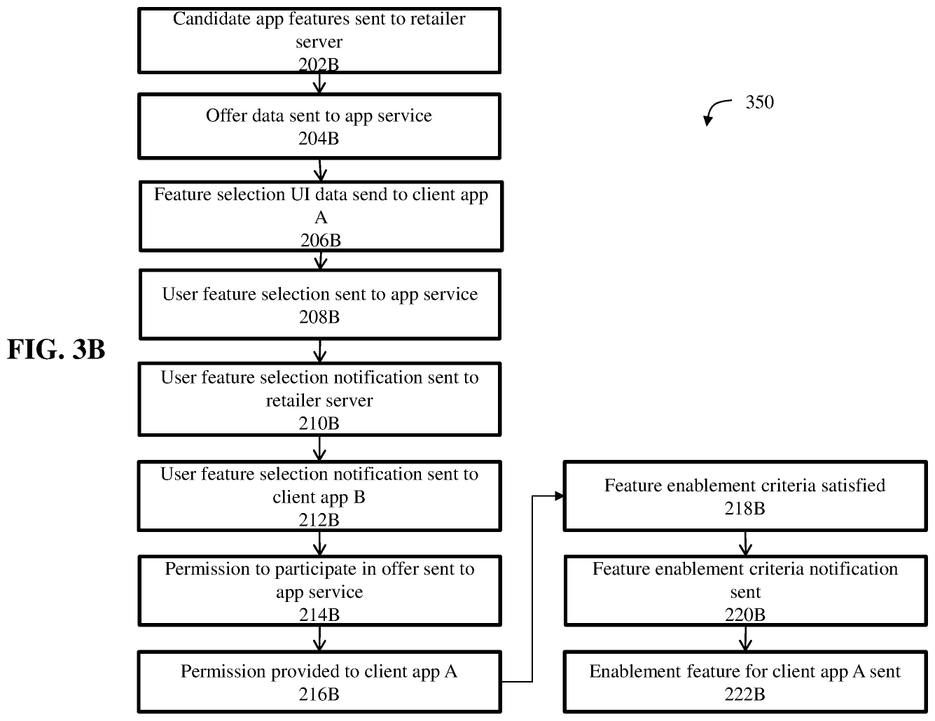

The process of increasing retail sales of goods and services over a communications network will now be described with reference to FIGS. 2A, 2B, 3A and 3B below. FIGS. 2A and 3A depict the data flow and control flow of the process for increasing retail sales of goods and services over a communications network 106, according to the first embodiment. FIGS. 2B and 3B depict the data flow and control flow of the process for increasing retail sales of goods and services over a communications network 106, according to the second embodiment. Dotted lines in FIGS. 2A and 2B indicate optional steps.

In the first embodiment of FIGS. 2A and 3A, the claimed process 300 begins with a first step 202, wherein the application service 230 transmits to the retailer server 220, over the communications network 106, one or more candidate application features that may be used in the course increasing retail sales by presenting offers to consumers. The retailer server selects one or more of the one or more candidate application features to determine which candidate application features to include in the offers it will present to the consumers. In step 204, the retailer server 220 transmits data that defines an offer to the application service. This data not only specifies one or more application features that are pertinent to the application service but also delineates feature enablement criteria for each application feature. This allows for dynamic interaction between the application service and the retailer's offerings, providing a tailored experience based on specific criteria met by the user or the environment.

Upon obtaining the offer data, in step 206, the application service 230 transmits it to the client application A 240, which offer data may be in the form of a feature selection user interface (UI) data. This data defines how the one or more application features in the offer is displayed on the client device 121 and/or 154. The user 111 and/or 144 then selects one or more application features from among the presented options. The selection process can also include the choice of an offer, demonstrating the system's flexibility in accommodating various user interactions and intents.

In step 208 the client application A 240 transmits to the application service the selection of one or more application features that was selected by the user 111 and/or 144. In step 210, the application service sends the selection of one or more application features in a notification to the retailer server 220. In one optional step after step 210, the retailer server transmits the selection of one or more application features in a notification to a client application. Thereafter, said client application responds to the retailer server with a qualifying purchase notification.

In step 216, the retailer server 220 detects that the feature enablement criteria for the selected application feature has been met. In one embodiment, to satisfy the criteria, the consumer 144 may have purchased a good or service from retailer 150 on her mobile computing device (via retailer server 130) or in person at a brick and mortar store of retailer 150.

In step 218, the application service receives a first indicator from the retailer server or a retailer mobile application, signaling that the feature enablement criteria have been satisfied. This could involve a range of conditions such as achieving a certain purchase amount, purchasing specific offer items, or confirming the proximity of the first client device to designated offer locations. The data defining the offer may further comprise user qualification criteria, details of the offer items, or the offer locations, enriching the contextual framework within which the application features operate.

In response to the receipt of the first indicator, in step 220, the application service proceeds to provide a second indicator to the first client application A. This second indicator confirms that the selected application feature is now enabled, enabling a direct and immediate acknowledgment of the user's fulfillment of the offer criteria.

The claimed embodiments extend their functionality to interactions with a second client application which may reside on the first or second client device. In the second embodiment of FIGS. 2B and 3B, the process 350 begins with a first step 202B, the application service 230 transmits to the retailer server 220, over the communications network 106, one or more candidate application features that may be used in the course of increasing retail sales by presenting offers to consumers. The retailer server selects one or more of the one or more candidate application features to determine which candidate application features to include in the offers it will present to the consumers. In step 204B, the retailer server 220 transmits data that defines an offer to the application service.

Upon obtaining the offer data, in step 206B, the application service 230 transmits it to the first client application A 240A on the first client device, which offer date may be in the form of a feature selection user interface (UI) data. The user then selects one or more application features from among the presented options. In step 208B the client application A 240A transmits to the application service the selection of one or more application features that was selected by the user 111. In step 210B, the application service sends the selection of the one or more application features in a notification to the retailer server 220. In step 212B, the application service 230 transmits to the second client application B 240B on the first or second client computing device the application features that were selected by the user 111. The data sent to the client application B encompasses a variety of identifiers and indicators including, but not limited to, a first identifier for the selected application feature(s), a third indicator for the feature enablement criteria for the selected application feature(s), and identifiers for both the first client application and device.

In step 214B, the second client application B 240B transmits to the application service 230 a permission to participate in the offer. The data sent to the application service may include a fourth indicator from the second client application, indicating permission to participate in the offer. In step 216B, the application service 230 transmits to the first client application A 240A the permission to participate in the offer via a fifth indicator. In one optional step after step 216B, the client application B 240B transmits a qualifying purchase notification to the retailer server.

In step 218B, the retailer server 220 detects that the feature enablement criteria for the selected application feature(s) have been met. In step 220B, the application service receives a first indicator from the retailer server or a retailer mobile application, signaling that the feature enablement criteria have been satisfied. In response to the receipt of the first indicator, in step 222B, the application service proceeds to provide a second indicator to the first client application A. This second indicator confirms that the selected application feature is now enabled, enabling a direct and immediate acknowledgment of the user's fulfillment of the offer criteria.

The scope of the claimed embodiments also incorporates scenarios where the first and second client devices are the same, illustrating the system's adaptability to different user configurations and preferences. Moreover, the application service may include a first client application program interface (API) configured to receive the data defining the offer and a second API to receive the first indicator, emphasizing the technical infrastructure that supports these complex interactions. Furthermore, the application service is capable of providing program code to modify the user interface (UI) of the first client application. This enables the display of graphical elements corresponding to the application features, thereby enhancing the user experience by visually representing the opportunities and actions available to the user based on the retailer's offers.

Through its comprehensive approach to obtaining data, receiving selections and indicators, and facilitating interactions between multiple client applications and devices, the invention offers a robust framework for enhancing user engagement and personalization in the context of retailer promotions and offers.

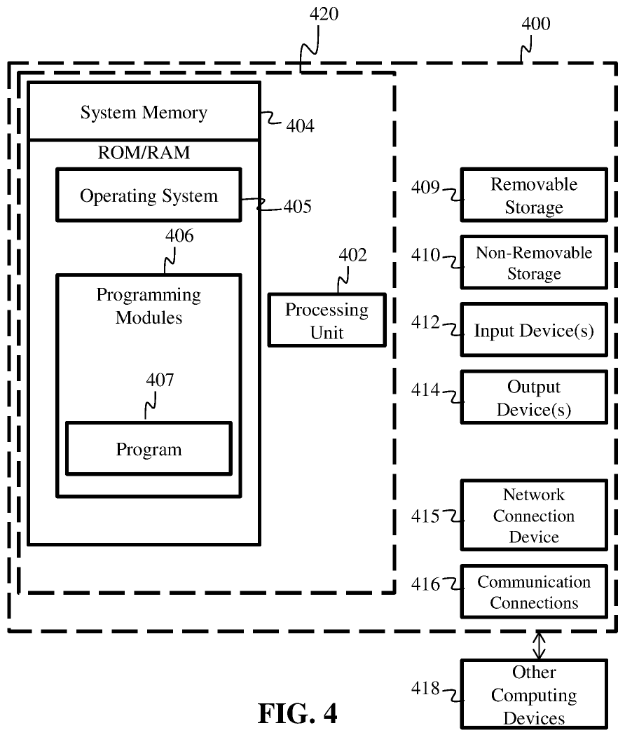

FIG. 4 is a block diagram of a system including an example computing device 400 and other computing devices. Consistent with the embodiments described herein, the aforementioned actions performed by 121, 154, 102, 130 may be implemented in a computing device, such as the computing device 400 of FIG. 4. Any suitable combination of hardware, software, or firmware may be used to implement the computing device 400. The aforementioned system, device, and processors are examples and other systems, devices, and processors may comprise the aforementioned computing device. Furthermore, computing device 400 may comprise an operating environment for system 100 and processes 300, 350, as described above. Processes 300, 350 may operate in other environments and are not limited to computing device 400.

With reference to FIG. 4, a system consistent with an embodiment may include a plurality of computing devices, such as computing device 400. In a basic configuration, computing device 400 may include at least one processing unit 402 and a system memory 404. Depending on the configuration and type of computing device, system memory 404 may comprise, but is not limited to, volatile (e.g. random-access memory (RAM)), non-volatile (e.g. read-only memory (ROM)), flash memory, or any combination or memory. System memory 404 may include operating system 405, and one or more programming modules 406. Operating system 405, for example, may be suitable for controlling computing device 400's operation. In one embodiment, programming modules 406 may include, for example, a program module 407 for executing the actions of 121, 154, 102, 130. Furthermore, embodiments may be practiced in conjunction with a graphics library, other operating systems, or any other application program and is not limited to any particular application or system. This basic configuration is illustrated in FIG. 4 by those components within a dashed line 420.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a camera, a touch input device, etc. Output device(s) 414 such as a display, speakers, a printer, etc. may also be included. Computing device 400 may also include a vibration device capable of initiating a vibration in the device on command, such as a mechanical vibrator or a vibrating alert motor. The aforementioned devices are only examples, and other devices may be added or substituted.

Computing device 400 may also contain a network connection device 415 that may allow device 400 to communicate with other computing devices 418, such as over a network in a distributed computing environment, for example, an intranet or the Internet. Device 415 may be a wired or wireless network interface controller, a network interface card, a network interface device, a network adapter or a LAN adapter. Device 415 allows for a communication connection 416 for communicating with other computing devices 418. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 404, including operating system 405. While executing on processing unit 402, programming modules 406 (e.g. program module 407) may perform processes including, for example, one or more of the stages of the processes 300, 350 as described above. The aforementioned processes are examples, and processing unit 402 may perform other processes. Other programming modules that may be used in accordance with embodiments herein may include electronic mail and contacts applications, word processing applications, spreadsheet applications, database applications, slide presentation applications, drawing or computer-aided application programs, etc.

Generally, consistent with embodiments herein, program modules may include routines, programs, components, data structures, and other types of structures that may perform particular tasks or that may implement particular abstract data types. Moreover, embodiments herein may be practiced with other computer system configurations, including hand-held devices, multiprocessor systems, microprocessor-based or programmable consumer electronics, minicomputers, mainframe computers, and the like. Embodiments herein may also be practiced in distributed computing environments where tasks are performed by remote processing devices that are linked through a communications network. In a distributed computing environment, program modules may be located in both local and remote memory storage devices.

Furthermore, embodiments herein may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments herein may also be practiced using other technologies capable of performing logical operations such as, for example, AND, OR, and NOT, including but not limited to mechanical, optical, fluidic, and quantum technologies. In addition, embodiments herein may be practiced within a general purpose computer or in any other circuits or systems.

Embodiments herein, for example, are described above with reference to block diagrams and/or operational illustrations of methods, systems, and computer program products according to said embodiments. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments have been described, other embodiments may exist. Furthermore, although embodiments herein have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the claimed subject matter.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart, flow diagram or sequence diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus comprising:
one or more processors; and
an application service executed by the one or more processors, the application service configured to:
obtain, from a retailer server, data defining an offer, the data indicating one or more application features corresponding to the application service, each application feature of the one or more application features having feature enablement criteria corresponding to the application feature,
receive, from a first client application via a communications network, a selection of an application feature of the one or more application features, the first client application executing on a first client device,
receive, from the retailer server, a first indicator indicating that the feature enablement criteria has been satisfied, and
in response to receipt of the first indicator, provide, to the first client application, a second indicator indicating that the selected application feature is enabled.

2. The apparatus of claim 1, wherein the first client application comprises a mobile gaming application.

3. The apparatus of claim 1, wherein to receive the first indicator indicating that the feature enablement criteria has been satisfied comprises to receive the first indicator from the retailer server or a retailer mobile application.

4. The apparatus of claim 1, wherein to receive the selection of the application feature comprises to receive a selection of the offer.

5. The apparatus of claim 1, wherein the data defining the offer further includes one or more of user qualification criteria, one or more offer items, or one or more offer locations.

6. The apparatus of claim 5, wherein the feature enablement criteria comprises one or more of a purchase amount, a purchase of at least one of the one or more offer items, or an indication that the first client device is located in proximity to at least one of the one or more offer locations.

7. The apparatus of claim 1, wherein the application service is further configured to:
in response to receipt of the selection of the application feature, provide to a second client application via the communications network, selected application feature data, the second client application executing on a second client device, the selected application feature data including one or more of a first identifier identifying the selected application feature, a third indicator indicating the feature enablement criteria corresponding to the selected application feature, a second identifier identifying the first client application, or a third identifier identifying the first client device.

8. The apparatus of claim 7, wherein the application service is further configured to receive, from the second client application via the communications network, a fourth indicator indicating permission to participate in the offer.

9. The apparatus of claim 8, wherein the application service is further configured to provide, to the first client application, a fifth indicator indicating that the fourth indicator indicating permission to participate in the offer has been received by the application service.

10. The apparatus of claim 7, wherein the feature enablement criteria comprises an indication that the second client device is located in proximity to a location indicated in the data defining the offer.

11. The apparatus of claim 7, wherein the second client application comprises a mobile retailer application.

12. The apparatus of claim 7, wherein the first client device and the second client device are the same device.

13. The apparatus of claim 1, wherein the application service includes a first client application program interface (API) configured to receive the data defining the offer.

14. The apparatus of claim 1, wherein the application service is configured to provide, to the first client application, program code to modify a user interface (UI) of the first client application to display one or more graphical elements corresponding to the one or more application features.

15. The apparatus of claim 1, wherein the application service includes a second API configured to receive the first indicator.

16. A method comprising:
obtaining, from a retailer server, data defining an offer, the data indicating one or more application features corresponding to a third-party application service, each application feature of the one or more application features having feature enablement criteria corresponding to the application feature;
receiving from a first client application via a communications network, a selection of an application feature of the one or more application features, the first client application executing on a first client device;
receiving, from the retailer server, a first indicator indicating that the feature enablement criteria has been satisfied; and
in response to the receiving of the first indicator, providing, to the first client application, a second indicator indicating the selected application feature is enabled.

17. The method of claim 16, wherein the receiving from the first client application the selection of the application feature comprises receiving a selection of the offer.

18. The method of claim 16, wherein the first client application comprises a mobile gaming application.

19. The method of claim 16, wherein the receiving the first indicator indicating that the feature enablement criteria has been satisfied comprises receiving the first indicator from the retailer server or a retailer mobile application.

20. The method of claim 16, wherein the data defining the offer further includes one or more of user qualification criteria, offer items, or offer locations.

21. The method of claim 16, wherein the feature enablement criteria comprises one or more of a purchase amount, a purchase of an item or items, or an indication that the first client device is located in proximity to at least one of the one or more offer locations indicated in the data defining the offer.

22. The method of claim 16, further comprising:
in response to the receiving of the selection of the application feature, providing to a second client application via the communications network, selected application feature data, the selected application feature data including one or more of a first identifier identifying the selected application feature, a third indicator indicating the feature enablement criteria corresponding to the selected application feature, a second identifier identifying the first client application, or a third identifier identifying the first client device.

23. The method of claim 22, further comprising:
receiving from the second client application via the communications network, a fourth indicator indicating permission to participate in the offer, the second client application executing on a second client device.

24. The method of claim 23, further comprising providing, to the first client application, a fifth indicator indicating that the fourth indicator indicating permission to participate in the offer has been received.

25. The method of claim 23, wherein the feature enablement criteria comprises an indication that the second client device is located in proximity to a location indicated in the data defining the offer.

26. The method of claim 23, wherein the first client device and the second client device are the same device.

27. The method of claim 22, wherein the second client application comprises a mobile retailer application.

28. The method of claim 16, further comprising providing, to the first client application, program code to modify a user interface (UI) of the first client application to display one or more graphical elements corresponding to the one or more application features.

29. A computer-readable medium having stored thereon executable instructions that, when executed, cause one or more processors to:
obtain, from a retailer server, data defining an offer, the data indicating one or more application features corresponding to a third-party application service, each application feature of the one or more application features having feature enablement criteria corresponding to the application feature;
receive, from a first client application via a communications network, a selection of an application feature of the one or more application features, the first client application executing on a first client device;
receive, from the retailer server, a first indicator indicating that the feature enablement criteria has been satisfied; and
in response to receipt of the first indicator, provide, to the first client application, a second indicator indicating that the selected application feature is enabled.

30. The computer-readable medium of claim 29, wherein the instructions further comprise instructions to cause the one or more processors to:
in response to receipt of the selection of the application feature, provide to a second client device via the communications network, selected application feature data, the selected application feature data including one or more of a first identifier identifying the selected application feature, a third indicator indicating the feature enablement criteria corresponding to the selected application feature, a second identifier identifying the first client application, or a third identifier identifying the first client device.

31. The computer-readable medium of claim 30, wherein the instructions further comprise instructions to cause the one or more processors to:
receive from a second client application via the communications network, a fourth indicator indicating permission to participate in the offer.
